(19) United States
(12) Patent Application Publication
(10) Pub. No.: US 2014/0221009 A1
(43) Pub. Date: Aug. 7, 2014

(54) METHOD, SYSTEM AND APPARATUS FOR COLLECTING LOCATION INFORMATION

(71) Applicant: Tencent Technology (Shenzhen) Company Limited, Shenzhen (CN)

(72) Inventor: Gang LIU, Shenzhen (CN)

(73) Assignee: Tencent Technology (Shenzhen) Company Limited, Shenzhen (CN)

(21) Appl. No.: 14/252,200

(22) Filed: Apr. 14, 2014

Related U.S. Application Data
(63) Continuation of application No. PCT/CN2013/072002, filed on Feb. 28, 2013.

(30) Foreign Application Priority Data
Feb. 29, 2012 (CN) 201210049873.2

(51) Int. Cl. H04W 4/02; H04W 64/00

(52) U.S. Cl. CPC H04W 4/023; H04W 64/003
USPC 455/456.1; 455/561

(57) ABSTRACT

Disclosed are a method, a system and an apparatus for collecting location information, belonging to the field of mobile positioning. The method comprises: acquiring a first correspondence between a first terminal, an access point (AP), and location information indicating a location of a second terminal when it connects to the AP, and obtaining location information of the first terminal according to the first correspondence. By means of the present invention, an AP serves as an intermediate between a first terminal and location information of a second terminal, and location information of the first terminal is obtained, so a terminal without positioning function is also enabled to obtain location information of the terminal, and location information collection is high in efficiency, convenient and fast, and low in cost.

### CROSS REFERENCE TO RELATED APPLICATIONS

This application is a continuation application of PCT Application PCT/CN2013/072002 filed on Feb. 28, 2013, claiming a priority from Chinese Application No. 201210049873.2, entitled “METHOD AND SYSTEM FOR COLLECTING LOCATION INFORMATION”, filed on Feb. 29, 2012. The aforementioned patent application is hereby incorporated by reference in its entirety.

### FIELD OF THE INVENTION

The invention relates to the field of mobile Internet, especially to the field of mobile positioning, and in particular to a method, a system and an apparatus for collecting location information.

### BACKGROUND

As the internet, especially the wireless network develops, more and more devices are accessing the mobile networks. In this situation, LBS (Location Based Service) are applied widely and currently there are three main positioning methods as below.

Firstly, a GPS based positioning method requires that a terminal needed to be positioned is with a GPS (Global Positioning System) chip, mainly satisfying the positioning demand of navigators and mobile phones, but cannot be used for indoor positioning due to issues of satellite signals.

Secondly, a positioning method based on base station of mobile operator requires that a terminal needed to be positioned is connected to a mobile network, but the precision achieved by this positioning method is low.

Thirdly, a WiFi (Wireless Fidelity) based positioning method which is rising recently, is well suitable for users of mobile office and has a broad market prospect, since WiFi has a main advantage that it does not require wiring and is not limited by any wiring conditions. The basic equipments for establishing a wireless network are a wireless card and a AP such that the network resources can be shared with a wireless mode in combination of the existing wired architecture. The cost and complexity for establishing a wireless network is much less than those of a conventional wired network. WiFi is widely used as a main technology of wireless AP. The range of radio wave of a Bluetooth technology is very small and generally has a radius of about 50 foot (i.e., 15 meters), while the range of WiFi radio wave is large and generally has a radius of about 300 foot (i.e., 100 meters), which thus can be used in an office as well as a whole building.

However, a difficult problem that a WiFi positioning method faces is the collecting of position information of positioning. Currently, the position information of WiFi positioning is mainly collected actively.

Current method of collecting location information has a low efficiency, a inconvenient operation and a high cost and cannot satisfy the demand for positioning a stationary terminal without positioning function.

### SUMMARY OF THE INVENTION

To solve a problem in prior art that the location information collection is low in efficiency, inconvenient, high in cost and cannot satisfy the demand for positioning a stationary terminal without positioning function, the embodiments of the invention provide a method, a system and an apparatus for collecting location information as below.

A method for collecting location information is provided, which comprises the steps of:

according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information;

according to an identification of an AP, which is connected to by a first terminal, transmitted by the first terminal, obtaining, from the third correspondence, location information corresponding to the identification of the AP, which is connected to by the first terminal, as location information of the first terminal; and

transmitting the location information of the first terminal to the first terminal.

A system for collecting location information is provided, which comprises a location information collecting server;

wherein the location information collecting server is configured to, according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information; according to an identification of an AP, which is connected to by a first terminal, transmitted by the first terminal, obtaining, from the third correspondence, location information corresponding to the identification of the AP, which is connected to by the first terminal, as location information of the first terminal; and transmit the location information of the first terminal to the first terminal.

An apparatus for collecting location information is provided, comprising:

a correspondence obtaining module for, according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information;

a location information obtaining module for, according to an identification of an AP, which is connected to by a first terminal, transmitted by the first terminal, obtaining, from the third correspondence, location information corresponding to the identification of the AP, which is connected to by the first terminal, as location information of the first terminal; and

a transmitting module for transmitting the location information of the first terminal to the first terminal.

By means of the technical solutions provided by embodiments of the invention, the following advantageous effects can be obtained: an AP serves as an intermediate between a first terminal and location information of a second terminal, and location information of the first terminal is obtained, so a terminal without positioning function is also enabled to obtain location information of the terminal, and location information collection is high in efficiency, convenient and fast, and low in cost.

### DESCRIPTION OF THE DRAWINGS

To more clearly explain the technical solutions of embodiments of the invention, drawings used in describing embodiments will be introduced simply. Obviously, the following drawings are merely some embodiments of the invention and other drawings can be obtained from these ones by those skilled in the art without any inventive work.

FIG. 1 is a flow diagram showing a method for collecting location information in a first embodiment of the invention;

FIG. 2 is a flow diagram showing a method for collecting location information in a second embodiment of the invention;

FIG. 3 is a flow diagram showing a method for collecting location information in a second embodiment of the invention;

FIG. 4 is a structure schematic diagram showing a location information collecting server in a third embodiment of the invention;

FIG. 5 is a structure schematic diagram showing a correspondence establishing module in a third embodiment of the invention;

FIG. 6 is a structure schematic diagram showing a system for collecting location information in a third embodiment of the invention;

FIG. 7 is a second structure schematic diagram showing a system for collecting location information in a third embodiment of the invention;

FIG. 8 is a structure schematic diagram of an interface server in a third embodiment of the invention; and

FIG. 9 is a third structure schematic diagram showing a system for collecting location information in a third embodiment of the invention.

### DETAILED DESCRIPTION

To make the object, the technical solution and the advantage of the invention clearer, the embodiments of the invention will be described in details with reference to drawings.

### Embodiment 1

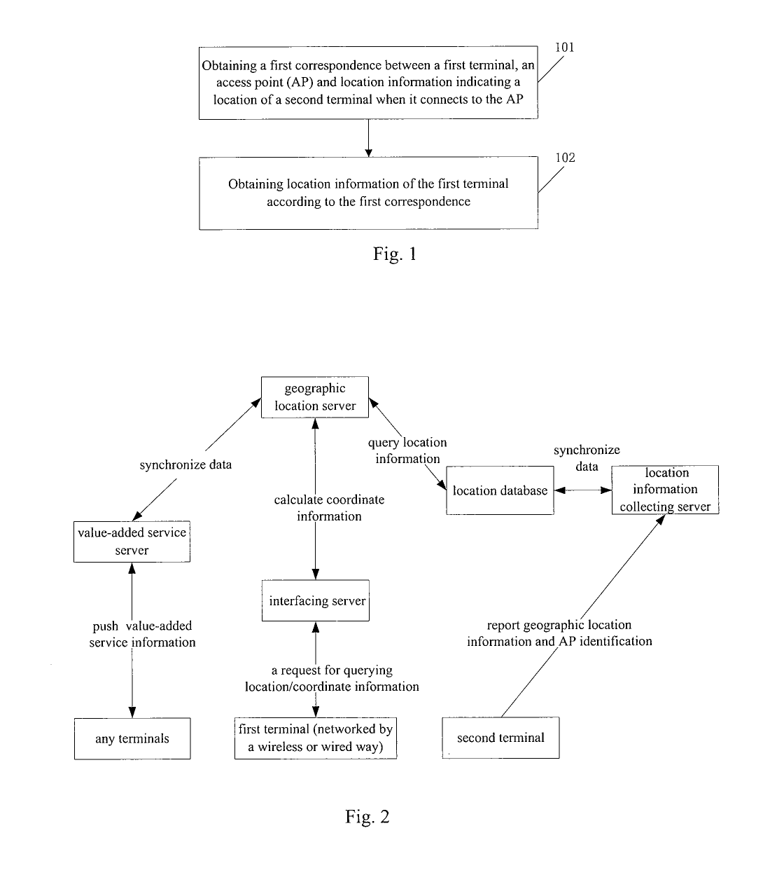

As shown in FIG. 1, the present embodiment provides a method for collecting location information, wherein a performing body of the method is a location information collecting server, in particular, a server established previously and with a location information collecting function, and a first terminal and a second terminal can be a personal computer, PC, mobile phone, tablet computer, mobile terminal etc. The method includes the following steps.

In step 101, a first correspondence between a first terminal, an access point (AP) and location information indicating a location of a second terminal when it connects to the AP can be acquired.

Specifically, according to an identification of an access point (AP), which is connected to by at least one second terminal, transmitted by the at least one second terminal and location information indicating a location of the at least one second terminal when it connects to the AP, an item of a third correspondence including the identification of the AP and the location information can be established.

Further, the step can include the following operations:

receiving an identification of an AP, which is connected to by a first terminal, transmitted by the first terminal and establishing a second correspondence between the AP and the first terminal;

receiving an identification of an AP, which is connected to by a second terminal, transmitted by the second terminal and location information indicating a location of the second terminal when it connects to the AP, and establishing an item of the third correspondence including the identification of the AP and the location information; and

deriving the first correspondence according to the second and third correspondences.

Actually, the above second correspondence represents a correspondence between an identification of the first terminal and the AP identification transmitted by the first terminal, while the first correspondence represents a correspondence mapped by the second and third correspondences. With the AP identification as an intermediate, a correspondence between the identification of the first terminal and the location information indicating the location of the second terminal when it connects to the AP can be known.

In step 102, location information of the first terminal can be obtained according to the first correspondence.

Specifically, according to the identification of the AP, which is connected to by a first terminal, transmitted by the first terminal and the third correspondence, it is possible to obtain, from the third correspondence, location information corresponding to the identification of the AP, which is connected to by the first terminal, as location information of the first terminal.

After the step 102, the embodiment can further include the step of transmitting the location information of the first terminal to the first terminal.

Optionally, the step of according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information comprises:

if there is an item of the third correspondence including the identification of the AP, which is connected to by the at least one second terminal, the item is replaced by the established item of the third correspondence.

Optionally, wherein the step of according to an identification of an AP, which is connected to by a first terminal, transmitted by the first terminal, obtaining, from the third correspondence, location information corresponding to the identification of the AP, which is connected to by the first terminal, as location information of the first terminal comprises:

obtaining the location information in the item of the third correspondence that is most recently established and includes the identification of the AP, which is connected to by the at least one second terminal, as location information of the first terminal.

Optionally, the step of according to an identification of an AP, which is connected to by a first terminal, transmitted by the first terminal, obtaining, from the third correspondence, location information corresponding to the identification of the AP, which is connected to by the first terminal, as location information of the first terminal comprises:

receiving a inquiring request transmitted by the first terminal, wherein the inquiring request carries identifications of APs and signal strength of respective APs obtained by the first terminal;

according to the obtained identifications of the APs and the third correspondence, obtaining location information corresponding to the obtained identifications of the APs; and

according to the location information corresponding to the obtained identifications of the APs and the signal strength of respective APs, correcting the location information of the first terminal.

Optionally, after the step of according to an identification of an AP, which is connected to by a first terminal, transmitted by the first terminal, obtaining, from the third correspondence, location information corresponding to the identification of the AP, which is connected to by the first terminal, as location information of the first terminal, the method further comprises the step of:

inquiring geographic information within a range of predetermined distance from the location of the first terminal and transmitting the inquired geographic information to the first terminal;

wherein the geographic information includes at least building information and traffic information.

Optionally, after the step of according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information, the method further comprises the step of:

receiving, from the first terminal, a request for inquiring devices within the range of the predetermined distance from the location of the first terminal, and according to the third correspondence, returning to the first terminal identifications of the devices within the range of the predetermined distance.

It should be noted that the present embodiment makes illustration by taking the first terminal being a device without positioning function and the second terminal being a device with positioning function as an example.

Therefore, the present embodiment of the invention provides a method for collecting location information, wherein an AP serves as an intermediate between a first terminal and location information of a second terminal, and location information of the first terminal is obtained, so that a terminal without positioning function is also enabled to obtain location information of the terminal, and location information collection is high in efficiency, convenient and fast, and low in cost.

### Embodiment 2

This embodiment provides a method for collecting location information which is improved based on the first embodiment. In the embodiment, a system shown in FIG. 2 is arranged for collecting location information and realizing positioning function, and the system can include:

a first terminal, a second terminal, a location information collecting server, a location database, an interfacing server, a geographic location server and a value-added service server. Actually, the location information collecting server, the location database, the interfacing server, the geographic location server and the value-added service server can be implemented by respective databases in a server cluster, or can be also implemented by respective functional modules on the same server. The embodiment of the invention makes illustrations merely by taking those servers having different functions for performing the method as an example.

The first terminal can be a stationary device without positioning function, such as a device connecting to a network via a wireless or wired way, but can have a function to inquire an AP signal. The method in the embodiment provides such a device without positioning function such as the first terminal with positioning function. The positioning process of the first terminal will be explained in steps 207-209 of the following embodiment.

The second terminal can be a device with positioning function and can inquire an AP signal, being configured to report location information to the location information collecting server to facilitate the collection of location information.

The location information collecting server is configured to collect location information, and to synchronize the collected location information with the location database. The details of the geographic location information collecting process will be explained in steps 201-206 of the following embodiment.

The location database is configured to store the collected location information for inquiring by the geographic location server.

The geographic location server is configured to calculate the coordinate information by using location information inquired from the location database, to obtain the coordinate information of the first terminal.

The interface server is configured to provide a direct interface between the geographic location server and the first terminal, forward a request for inquiring a location transmitted by the first terminal, and forward the coordinate information of the first terminal transmitted by the geographic location server to the first terminal.

The value-added service server is configured to provide a terminal with a value-added service, coordinate information or geographic information near the terminal, such as pushing to a terminal the building information and traffic information etc. near the terminal.

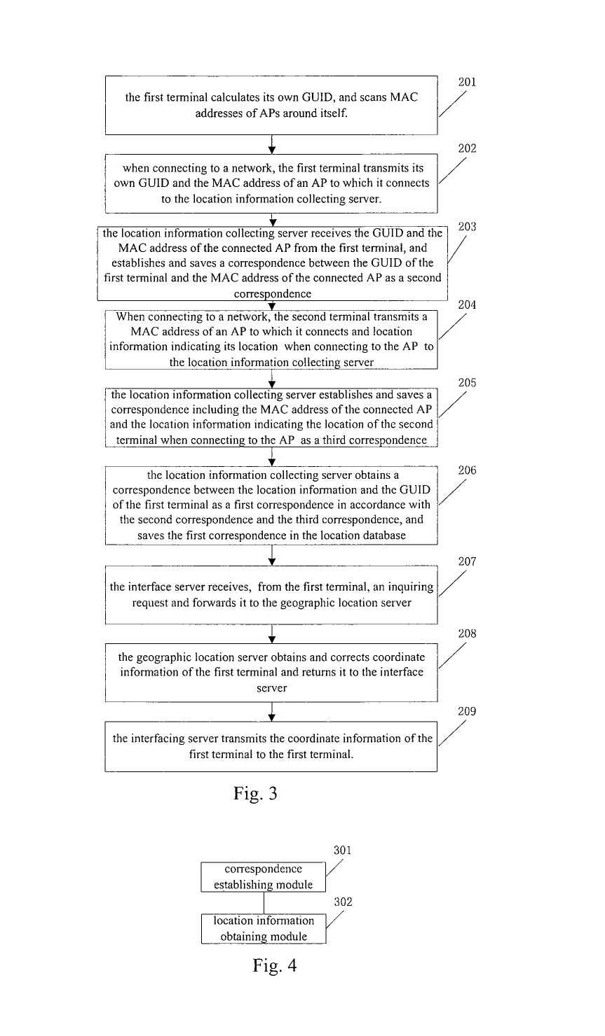

As shown in FIG. 3, a method for collecting location information is provided, including the following steps.

In step 201, the first terminal calculates its own unique identification GUID, and scans MAC address of AP around itself.

In the embodiment of the invention, illustrations will be made merely by taking the identification of AP being MAC address of AP as an example wherein a MAC address corresponds to a unique AP.

Specifically, the GUID is a unique identification of a terminal, and the calculating method thereof generally can include: obtaining MAC address of network card and/or device series number of hardware disk of the first terminal, transforming them uniformly into character strings, then performing a Hash algorithm such as MD5 (Message Digest Algorithm MD5) or SHA (Secure Hash Algorithm), thereby obtaining a unique GUID identification of the first terminal.

In addition, each terminal device may execute a media application, an instant messaging application and other tool applications. The respective tool applications can obtain GUID as a unique identification of a terminal in accordance with the uniform unique identification calculating method.

When scanning by the first terminal, if there are MAC addresses of multiple APs, it can also obtain signal strength of the above APs.

In the embodiment, the first terminal can be positioned by using MAC information if it is connected to internet via a wireless way, or can be positioned by using GUID if it is connected to internet via a wired way. With such a technical solution, a terminal can be positioned regardless of whether or not the terminal is with a GPS module and whether the terminal is connected to internet via a wireless way or a wired way. Through the integrating of wireless device and wired device, a stationary device is enabled to detect devices around it without using GPS and the specific method will be described in the steps below.

In step 202, when connecting to a network, the first terminal transmits its own GUID and the obtained MAC address of AP to the location information collecting server.

In step 203, the location information collecting server receives the GUID and the MAC address of the AP from the first terminal, and establishes and saves a correspondence between the GUID of the first terminal and the MAC address of the AP as a second correspondence.

Specifically, the second correspondence obtained in this step is a correspondence between the AP connected to by the first terminal and the GUID of the first terminal.

In step 204, when connecting to a network, the second terminal transmits location information of the second terminal and MAC address of an AP, which is connected to by the second terminal, to the location information collecting server.

As described above, the second terminal is a device with positioning function and the location information can be GPS information or location information indicating a location of the second terminal when it connects to the AP obtained by using other existing technologies.

For example, the second terminal can collect location information through a sign-in function by collecting GPS information of WiFi hot spots or access points (for example, an instant messaging application has a geographic information service sign-in plug, which can be used for sharing location information and collecting the location information), or by means of GPS positioning function of a mobile device when the mobile device connects to Internet via a stationary device (for example, when a PC connects with a mobile phone, the positioning information can be recorded by means of the mobile phone).

It should be noted that, the location information collecting process in steps 201-204 implemented by the first and second terminals can be implemented by respective software modules with above functions. For example, these software modules can be built in an application, such as a downloading tool, a typing tool or a player, installed in the first and second terminals and a uniform GUID algorithm can be set.

In step 205, the location information collecting server establishes and saves a correspondence including location information indicating a location of the second terminal when it connects to the AP and the MAC address of the AP as an item of a third correspondence. If there is an item of the third correspondence including the identification of the AP, which is connected to by the at least one second terminal, the item is replaced by the established item of the third correspondence.

Specifically, the step enables the AP to establish a mapping relationship with the GPS information by using MAC identification of AP.

In step 206, when according to an identification of an AP, which is connected to by a first terminal, transmitted by the first terminal, obtaining, from the third correspondence, location information corresponding to the identification of the AP, which is connected to by the first terminal, as location information of the first terminal, the location information collecting server obtains the location information in the item of the third correspondence that is most recently established and includes the identification of the AP, which is connected to by the at least one second terminal, as location information of the first terminal.

The location information collecting server obtains a correspondence between the location information and the GUID of the first terminal as a first correspondence in accordance with the second correspondence and the third correspondence, and saves the first correspondence in the location database.

The location database is configured to save the first correspondence, i.e., a correspondence between the three, GUID [symbol] MAC address of AP [symbol] location information, and can be updated by the location information collecting server and inquired by the geographic location server at any time.

It should be noted that, the steps 204-206 can be asynchronous with the steps 201-203, that is, the steps 204-206 can be performed before the steps 201-203. A relationship between AP and location information can be determined by collecting location information of terminals around the AP via steps 204-206, and then in the subsequent process of inquiring a geographic location, location information of a stationary terminal (i.e., the first terminal) which accessed the known AP can be obtained according to the relationship between the known AP and location information.

In step 207, the interface server receives a inquiring request transmitted by the first terminal and forwards it to the geographic location server.

The interface server is an entrance for providing a terminal with a geographic location inquiring, and also has a function for inquiring devices near the current location of the terminal.

The inquiring request at least includes GUID of the first terminal, and can further include MAC addresses of ambient APs and signal strength of APs detected by the first terminal.

In step 208, the geographic location server obtains and corrects coordinate information of the first terminal and returns it to the interfacing server.

Further, the steps 207 and 208 includes the following steps: the interface server receives the inquiring request transmitted by the first terminal and forwards it to the geographic location server, wherein the inquiring request carries identifications of the APs and signal strength of respective APs obtained by the first terminal.

The geographic location server is configured to, according to the obtained identifications of the APs and the third correspondence, obtain location information corresponding to the obtained identifications of the APs, wherein the location information is the location information indicating the location of the at least one second terminal when it connects to the AP; and according to the location information corresponding to the obtained identifications of the APs and the signal strength of respective APs, correct the location information of the first terminal.

During a practical application, the step includes the following operations: inquiring, by the geographic location server, the location information of the first terminal in the location database according to the GUID of the first terminal; and determining, by the geographic location server, the location information of the first terminal by correcting the location information of the first terminal according to the MAC addresses and signal strength of APs obtained by the first terminal. Since the geographic location server also stores MAC addresses of APs and signal strength of respective APs uploaded by respective second terminal devices, the obtained location information of the first terminal can be corrected according to the signal strength.

For example, when the inquiring request carries identifications of a plurality of APs and signal strength of respective AP obtained by the first terminal, the obtained location information of the first terminal can be corrected to location information corresponding to the AP with the strongest signal strength. In the circumstances that the geographic location server still saves the signal strength of respective APs, it is possible to correct the location information of the first terminal in the following manner. For example, if there are several items of the third correspondence for the same AP, the obtained location information of the first terminal can be corrected to location information included in an item including the AP with the strongest signal strength.

In addition, the step of returning the coordinate information of a terminal to the interface server can further include that:

the geographic location server transmits the coordinate information within a range of predetermined distance from the location of the first terminal to the first terminal via the interfacing server, for buffering by the first terminal.

In step 209, the interface server transmits the coordinate information of the first terminal to the first terminal.

When transmitting, by the interfacing server, the coordinate information of the first terminal to the first terminal, the method can further include that:

the value-added service server inquires geographic information within a range of predetermined distance from the location of the first terminal and transmitting the inquired geographic information to the first terminal via the interfacing server, for buffering by the first terminal, such that once the first terminal is successfully positioned, the first terminal can be positioned within a certain range even if disconnecting from the network.

The geographic information can include building information such as banks, restaurants and the like, as well as traffic information such as bus stations, traffic lights, names of streets and the like.

The first terminal such as a stationary terminal or a terminal without GPS module information, if connecting to a network via a wireless way, can report the unique GUID identification of its machine and the MAC address of wireless AP to a location server at backend; the second terminal with a GPS positioning module can report the positioned location information and the MAC address of AP accessed wirelessly via a sign-in function, which can be managed together in a location database. In this way, it is capable of improving the efficiency for collecting location information and obtaining a large amount of location related information in a short time, meanwhile an accessing device not connected with a wireless network such as a PC can also use location information and a stationary device can also scan and position the nearby wireless devices with the help of a background location server, thereby establishing a bridge for integrating wireless and wired devices.

Therefore, the present embodiment of the invention provides a method for collecting location information, wherein an AP serves as an intermediate between a first terminal and location information of a second terminal, and location information of the first terminal is obtained, so that a terminal without positioning function is also enabled to obtain location information of the terminal, and location information collection is high in efficiency, convenient and fast, and low in cost.

### Embodiment 3

The present embodiment provides a system for collecting location information which includes a location information collecting server 30.

Wherein as shown in FIG. 4, the location information collecting server 30 includes:

a correspondence establishing module 301 configured to acquire a first correspondence between a first terminal, an access point (AP) and location information indicating a location of a second terminal when it connects to the AP; and

a location information obtaining module 302 configured to obtain location information of the first terminal according to the first correspondence.

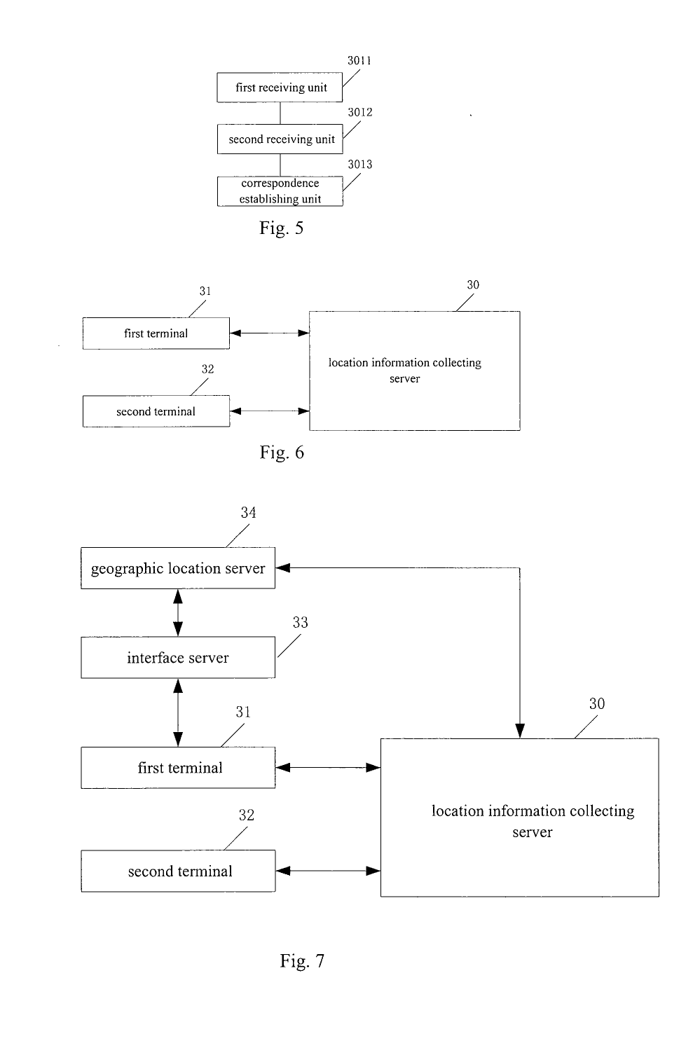

Further, as shown in FIG. 5, the correspondence establishing module 301 can include:

a first receiving unit 3011 configured to receive identification of an AP, which is connected to by the first terminal, transmitted by the first terminal and establish a second correspondence between the first terminal and the AP;

a second receiving unit 3012 configured to receive an identification of an AP, which is connected to by the second terminal, transmitted by the second terminal and location information indicating the location of the second terminal when it connects to the AP, and establish an item of a third correspondence including the identification of the AP and the location information; and

a correspondence establishing unit 3013 configured to obtain the first correspondence according to the second and third correspondence.

In addition, as shown in FIG. 6, the system further includes:

a first terminal 31 configured to transmit an identification of an AP, which is connected to by the first terminal, to the location information collecting server 30; and

a second terminal 32 configured to transmit an identification of an AP, which is connected to by the second terminal, and its own location information to the location information collecting server 30.

In addition, as shown in FIG. 7, the system further includes an interface server 33 and a geographic location server 34.

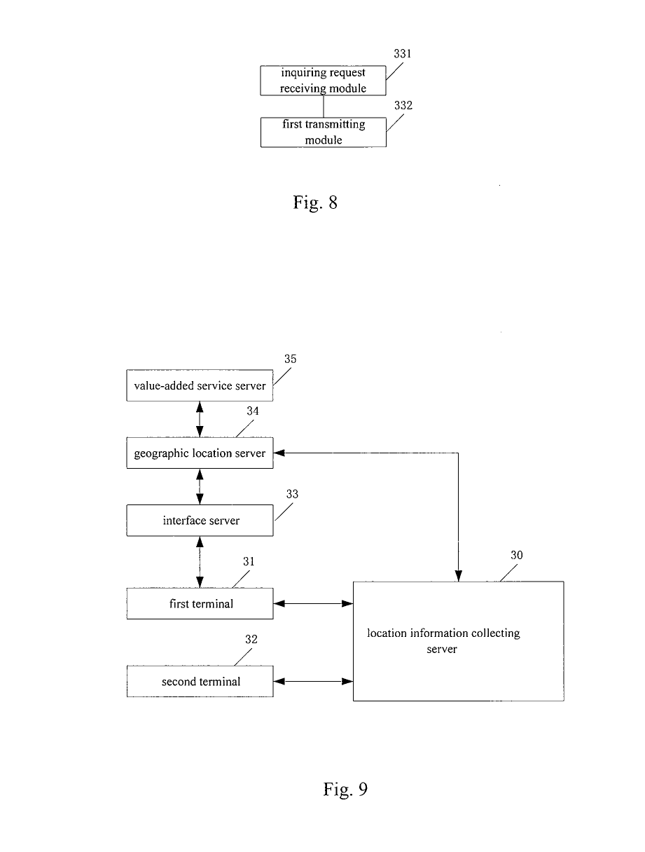

As shown in FIG. 8, the interface server 33 can include:

a inquiring request receiving module 331 configured to receive a inquiring request transmitted by the first terminal 31 and forward the inquiring request to the geographic location server 34; and

a first transmitting module 332 configured to transmit coordinate information of the first terminal 31 to the first terminal 31.

The geographic location server 34 is configured to calculate the coordinate information of the first terminal 31 according to the location information of the first terminal 31, the identifications of APs and the signal strength obtained by the first terminal 31, and return the coordinate information of the first terminal 31 to the interface server 33.

In addition, the geographic location server 34 is further configured to transmit the coordinate information within a range of predetermined distance from the location of the first terminal 31 to the first terminal 31 via the interface server 33, when the interface server 33 transmits the coordinate information of the first terminal 31 to the first terminal 31.

In addition, as shown in FIG. 9, the system further includes a value-added service server 35.

When the interface server 33 transmits the coordinate information of the first terminal 31 to the first terminal 31, the value-added service server 35 is configured to inquire the geographic information within a range of predetermined distance from the location of the first terminal 31 and transmit the inquired geographic information to the first terminal 31 via the interface server 33.

The geographic information includes at least building information and traffic information.

In addition, the interface server 33 is further configured to receive a request for inquiring devices within the range of the predetermined distance transmitted by the first terminal 31, and return, to the first terminal 31, identifications of the devices within the range of the predetermined distance from the location of the first terminal 31.

In addition, the first terminal 31 is a stationary device without positioning function and the second terminal 32 is a device with positioning function.

The embodiment of the invention provides a system for collecting location information, comprising a location information collecting server;

wherein the location information collecting server is configured to, according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information; according to an identification of an AP, which is connected to by a first terminal, transmitted by the first terminal, obtaining, from the third correspondence, location information corresponding to the identification of the AP, which is connected to by the first terminal, as location information of the first terminal; and transmit the location information of the first terminal to the first terminal.

When according to an identification of an access point (AP), which is connected to by at least one second terminal, transmitted by the at least one second terminal and location information indicating a location of the at least one second terminal when it connects to the AP, establishing an item of a third correspondence including the identification of the AP and the location, the location information collecting server is configured that, if there is an item of the third correspondence including the identification of the AP, which is connected to by the at least one second terminal, the item is replaced by the established item of the third correspondence.

When according to an identification of an AP, which is connected to by a first terminal, transmitted by the first terminal, obtaining, from the third correspondence, location information corresponding to the identification of the AP, which is connected to by the first terminal, as location information of the first terminal, the location information collecting server is configured to obtain the location information in the item of the third correspondence that is most recently established and includes the identification of the AP, which is connected to by the at least one second terminal, as location information of the first terminal.

The location information collecting server is configured to, receive a inquiring request transmitted by the first terminal, wherein the inquiring request carries identifications of APs and signal strength of respective APs obtained by the first terminal; according to the obtained identifications of the APs and the third correspondence, obtain location information corresponding to the obtained identifications of the APs; and according to the location information corresponding to the obtained identifications of the APs and the signal strength of respective APs, correct the location information of the first terminal.

The system further comprises a value-added service server;

the value-added service server is configured to inquiring geographic information within a range of predetermined distance from the location of the first terminal and transmit the inquired geographic information to the first terminal;

wherein the geographic information includes at least building information and traffic information.

The system further comprises: an interface server for receiving, from the first terminal, a request for inquiring devices within the range of the predetermined distance from the location of the first terminal, and according to the third correspondence, returning, to the first terminal, identifications of the devices within the range of the predetermined distance.

The first terminal is a stationary device without positioning function and the second terminal is a device with positioning function

Therefore, the present embodiment of the invention provides a system for collecting location information, wherein an AP serves as an intermediate between a first terminal and location information of a second terminal, and location information of the first terminal is obtained, so that a terminal without positioning function is also enabled to obtain location information of the terminal, and location information collection is high in efficiency, convenient and fast, and low in cost.

The embodiment of the invention also provides an apparatus for collecting location information, the apparatus comprising:

a correspondence obtaining module for, according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information;

a location information obtaining module for, according to an identification of an AP, which is connected to by a first terminal, transmitted by the first terminal, obtaining, from the third correspondence, location information corresponding to the identification of the AP, which is connected to by the first terminal, as location information of the first terminal; and

a transmitting module for transmitting the location information of the first terminal to the first terminal.

When according to an identification of an access point (AP), which is connected to by at least one second terminal, transmitted by the at least one second terminal and location information indicating a location of the at least one second terminal when it connects to the AP, establishing an item of a third correspondence including the identification of the AP and the location, the correspondence obtaining module is configured that if there is an item of the third correspondence including the identification of the AP, which is connected to by the at least one second terminal, the item is replaced by the established item of the third correspondence.

When according to an identification of an AP, which is connected to by a first terminal, transmitted by the first terminal, obtaining, from the third correspondence, location information corresponding to the identification of the AP, which is connected to by the first terminal, as location information of the first terminal, the location information obtaining module is configured to obtain the location information in the item of the third correspondence that is most recently established and includes the identification of the AP, which is connected to by the at least one second terminal, as location information of the first terminal.

The location information obtaining module is configured to receive receive a inquiring request transmitted by the first terminal, wherein the inquiring request carries identifications of APs and signal strength of respective APs obtained by the first terminal;

according to the obtained identifications of the APs and the third correspondence, obtain location information corresponding to the obtained identifications of the APs; and

according to the location information corresponding to the obtained identifications of the APs and the signal strength of respective APs, correct the location information of the first terminal.

The apparatus further comprises:

a inquiring module for inquiring geographic information within a range of predetermined distance from the location of the first terminal and transmitting the inquired geographic information to the first terminal;

wherein the geographic information includes at least building information and traffic information.

The apparatus further comprises:

an ambient device inquiring module for receiving, from the first terminal, a request for inquiring devices within the range of the predetermined distance from the location of the first terminal, and according to the third correspondence, returning to the first terminal identifications of the devices within the range of the predetermined distance.

The first terminal is a stationary device without positioning function and the second terminal is a device with positioning function

Therefore, the present embodiment of the invention provides an apparatus for collecting location information, wherein an AP serves as an intermediate between a first terminal and location information of a second terminal, and location information of the first terminal is obtained, so that a terminal without positioning function is also enabled to obtain location information of the terminal, and location information collection is high in efficiency, convenient and fast, and low in cost.

As can be appreciated by those skilled in the art, all or part of steps for implementing the above embodiments can be performed by hardware or can be performed by related hardware instructed by program, wherein the program can be stored on a computer readable storage medium which can be a read-only memory, a magnetic disk or a compact disk etc.

The above descriptions are merely preferred embodiments of the present invention and do not intend to limit the invention. Any modifications, alternations or improvements made without departing from the spirit and principle of the present invention should fall within the protection scope of the present invention.

What is claimed is:

1. A method for collecting location information, wherein the method comprises the steps of:
according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information;
according to an identification of an AP, which is connected to by a first terminal, transmitted by the first terminal, obtaining, from the third correspondence, location information corresponding to the identification of the AP, which is connected to by the first terminal, as location information of the first terminal; and
transmitting the location information of the first terminal to the first terminal.

2. The method according to claim 1, wherein the step of according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information comprises:
if there is an item of the third correspondence including the identification of the AP, which is connected to by the at least one second terminal, the item is replaced by the established item of the third correspondence.

3. The method according to claim 1, wherein the step of according to an identification of an AP, which is connected to by a first terminal, transmitted by the first terminal, obtaining, from the third correspondence, location information corresponding to the identification of the AP, which is connected to by the first terminal, as location information of the first terminal comprises:
obtaining the location information in the item of the third correspondence that is most recently established and includes the identification of the AP, which is connected to by the at least one second terminal, as location information of the first terminal.

4. The method according to claim 1, wherein the step of according to an identification of an AP, which is connected to by a first terminal, transmitted by the first terminal, obtaining, from the third correspondence, location information corresponding to the identification of the AP, which is connected to by the first terminal, as location information of the first terminal comprises:
receiving a inquiring request transmitted by the first terminal, wherein the inquiring request carries identifications of APs and signal strength of respective APs obtained by the first terminal;
according to the obtained identifications of the APs and the third correspondence, obtaining location information corresponding to the obtained identifications of the APs; and
according to the location information corresponding to the obtained identifications of the APs and the signal strength of respective APs, correcting the location information of the first terminal.

5. The method according to claim 1, wherein after the step of according to an identification of an AP, which is connected to by a first terminal, transmitted by the first terminal, obtaining, from the third correspondence, location information corresponding to the identification of the AP, which is connected to by the first terminal, as location information of the first terminal, the method further comprises the step of:
inquiring geographic information within a range of predetermined distance from the location of the first terminal and transmitting the inquired geographic information to the first terminal;
wherein the geographic information includes at least building information and traffic information.

6. The method according to claim 1, wherein after the step of according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information, the method further comprises the step of:
receiving, from the first terminal, a request for inquiring devices within the range of the predetermined distance from the location of the first terminal, and according to the third correspondence, returning to the first terminal identifications of the devices within the range of the predetermined distance.

7. The method of claim 1, wherein the first terminal is a stationary device without positioning function and the second terminal is a device with positioning function.

8. A system for collecting location information, wherein the system comprises a location information collecting server;
wherein the location information collecting server is configured to, according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information; according to an identification of an AP, which is connected to by a first terminal, transmitted by the first terminal, obtaining, from the third correspondence, location information corresponding to the identification of the AP, which is connected to by the first terminal, as location information of the first terminal; and transmit the location information of the first terminal to the first terminal.

9. The system according to claim 8, wherein when according to an identification of an access point (AP), which is connected to by at least one second terminal, transmitted by the at least one second terminal and location information indicating a location of the at least one second terminal when it connects to the AP, establishing an item of a third correspondence including the identification of the AP and the location, the location information collecting server is configured that,
if there is an item of the third correspondence including the identification of the AP, which is connected to by the at least one second terminal, the item is replaced by the established item of the third correspondence.

10. The system according to claim 8, wherein when according to an identification of an AP, which is connected to by a first terminal, transmitted by the first terminal, obtaining, from the third correspondence, location information corresponding to the identification of the AP, which is connected to by the first terminal, as location information of the first terminal, the location information collecting server is configured to,
obtain the location information in the item of the third correspondence that is most recently established and includes the identification of the AP, which is connected to by the at least one second terminal, as location information of the first terminal.

11. The system according to claim 8, wherein the location information collecting server is configured to, receive a inquiring request transmitted by the first terminal, wherein the inquiring request carries identifications of APs and signal strength of respective APs obtained by the first terminal; according to the obtained identifications of the APs and the third correspondence, obtain location information corresponding to the obtained identifications of the APs; and according to the location information corresponding to the obtained identifications of the APs and the signal strength of respective APs, correct the location information of the first terminal.

12. The system according to claim 8, wherein the system further comprises a value-added service server;
the value-added service server is configured to inquire geographic information within a range of predetermined distance from the location of the first terminal and transmit the inquired geographic information to the first terminal;
wherein the geographic information includes at least building information and traffic information.

13. The system according to claim 8, wherein the system further comprises: an interface server for receiving, from the first terminal, a request for inquiring devices within the range of the predetermined distance from the location of the first terminal, and according to the third correspondence, returning to the first terminal identifications of the devices within the range of the predetermined distance.

14. The system according to claim 8, wherein the first terminal is a stationary device without positioning function and the second terminal is a device with positioning function.

15. An apparatus for collecting location information, wherein the apparatus comprises:
a correspondence obtaining module for, according to an identification of an access point (AP), which is connected to by at least one second terminal, transmitted by the at least one second terminal and location information indicating a location of the at least one second terminal when it connects to the AP, establishing an item of a third correspondence including the identification of the AP and the location information;
a location information obtaining module for, according to an identification of an AP, which is connected to by a first terminal, transmitted by the first terminal, obtaining, from the third correspondence, location information corresponding to the identification of the AP, which is connected to by the first terminal, as location information of the first terminal; and
a transmitting module for transmitting the location information of the first terminal to the first terminal.

16. The apparatus according to claim 15, wherein when according to an identification of an access point (AP), which is connected to by at least one second terminal, transmitted by the at least one second terminal and location information indicating a location of the at least one second terminal when it connects to the AP, establishing an item of a third correspondence including the identification of the AP and the location, the correspondence obtaining module is configured that,
if there is an item of the third correspondence including the identification of the AP, which is connected to by the at least one second terminal, the item is replaced by the established item of the third correspondence.

17. The apparatus according to claim 15, wherein when according to an identification of an AP, which is connected to by a first terminal, transmitted by the first terminal, obtaining, from the third correspondence, location information corresponding to the identification of the AP, which is connected to by the first terminal, as location information of the first terminal, the location information obtaining module is configured to,
obtain the location information in the item of the third correspondence that is most recently established and includes the identification of the AP, which is connected to by the at least one second terminal, as location information of the first terminal.

18. The apparatus according to claim 15, wherein the location information obtaining module is configured to receive a inquiring request transmitted by the first terminal, wherein the inquiring request carries identifications of APs and signal strength of respective APs obtained by the first terminal;
according to the obtained identifications of the APs and the third correspondence, obtain location information corresponding to the obtained identifications of the APs; and
according to the location information corresponding to the obtained identifications of the APs and the signal strength of respective APs, correct the location information of the first terminal.

19. The apparatus according to claim 15, wherein the apparatus further comprises:
a inquiring module for inquiring geographic information within a range of predetermined distance from the location of the first terminal and transmitting the inquired geographic information to the first terminal;
wherein the geographic information includes at least building information and traffic information.

20. The apparatus according to claim 15, wherein the apparatus further comprises:
an ambient device inquiring module for receiving, from the first terminal, a request for inquiring devices within the range of the predetermined distance from the location of the first terminal, and according to the third correspondence, returning to the first terminal identifications of the devices within the range of the predetermined distance.

21. The apparatus of claim 15, wherein the first terminal is a stationary device without positioning function and the second terminal is a device with positioning function.
